(19) United States
(12) Patent Application Publication
(10) Pub. No.: US 2009/0119719 A1
(43) Pub. Date: May 7, 2009

(54) DEVICE REGISTRATION SYSTEM, SERVER, AND TERMINAL DEVICE

(76) Inventors: Natsume Matsuzaki, Osaka (JP); Naoshi Usuki, Kyoto (JP); Hiroyuki Iitsuka, Osaka (JP); Hiroki Yamauchi, Osaka (JP)

Correspondence Address: WENDEROTH, LIND & PONACK L.L.P., 1030 15th Street, N.W., Suite 400 East, Washington, DC, 20005-1503, US

(21) Appl. No.: 10/584,851

(22) PCT Filed: Jan. 6, 2005
(86) PCT No.: PCT/JP2005/000046

§ 371 Date: Jan. 5, 2009

(30) Foreign Application Priority Data
Jan. 7, 2004 (JP) 2004-002322

(51) Int. Cl. H04N 7/18; H04N 7/173

(52) U.S. Cl. 725/74; 725/116

(57) ABSTRACT

A device registration system for registering a terminal device for obtaining and using contents in a server that stores contents. The server stores a contents list indicating contents stored and a registration list for registering specific information to the terminal device. The server receives the specific information and transmits the contents list to the terminal device. The terminal device receives a selection of a content from the contents list according to input by a user and requests the server to transmit the selected content. When the specific information to the terminal device of the request source is not registered in the registration list, the server performs a registration process and transmits the requested content to the terminal device.

### TECHNICAL FIELD

The present invention relates to a device registration system that registers a new device as a member of group of devices that are allowed to use contents via a network.

### BACKGROUND ART

Recently, digital copyrighted works (hereafter referred to as the “contents”) such as music, images, and games have become easy to obtain due to a spread of the Internet, a digital broadcast, and a package media. In order to prevent unauthorized third people from using the contents and permit authorized people to use the contents, a technique to form a group of a plurality of authorized devices is used. This technique permits devices in the group to use the contents, and prohibits devices outside the group from using the contents.

When forming a group, information of a new device is registered with a server. When a registration process is completed, the new device is allowed to use the contents as a device in the group. It should be noted here that one of techniques to register devices by forming a group is disclosed in Patent Document 1.

### Patent Document 1: Japanese Laid-open Patent Application No. 2002-169726

Non-Patent Document 1: Broadband Dictionary, [Searched on Jan. 6, 2004]<URL: http://dictionary.rbbtoday.com/Details/term2278.html>

### DISCLOSURE OF THE INVENTION

### Problem to be Solved

As described above, when contents are used within a group, users need to register a device, and then, select contents to use. Therefore, users need to perform an operation to register in addition to an operation to use contents.

However, to register a device, users need to input information of the device and specify an ID of a server in which the device is to be registered. Therefore, the process requires complicated operations, and this is inconvenient for users.

The aim of the present invention is to provide a device registration system with which users can register a new device as the group member easily without performing complicated register operations in the case where a plurality of devices form a group via a network.

### Means for Solving the Problem

The present invention is a device registration system including a server and a terminal device obtaining and using the contents from the server, the terminal device comprising: a selection receiving unit operable to receive, according to input by a user, a selection of a content from a contents list showing the contents stored in the server; and a requesting unit operable to transmit, to the server, a request for the selected content, and the server comprising: a receiving unit operable to receive the request for the selected content from the terminal device; and a registration unit operable to register the terminal device on receipt of the request for the selected content.

### EFFECT OF THE INVENTION

The present invention is the terminal device having the above-described structure.

The present invention is a server that stores contents to be used by a terminal device, the server comprising: a receiving unit operable to receive, from the terminal device, a request for a content among the contents; and a registration unit operable to register the terminal device on receipt of the request for the content.

Also, the present invention is a terminal device that obtains and uses contents stored in a server, the terminal device comprising: a selection receiving unit operable to receive, according to input by a user, a selection of a content from a contents list showing the contents stored in the server; and a requesting unit operable to transmit, to the server, a request for the selected content, wherein the server registers the terminal device on receipt of the request for the content.

With this structure, the terminal device is registered automatically, without having the user perform a register operation, when the content is selected. Therefore, it is possible to increase user convenience.

Here, the present invention my further comprises: a storage unit operable to store a registration list; a specific information receiving unit operable to receive information specific to the terminal device which is a source of the request; and a judging unit operable to judge whether the received information is registered in the registration list, wherein if the judging unit judges negatively, the registration unit may register the terminal device by writing the received information in the registration list.

With this structure, the server judges whether the terminal device is registered. Therefore, the user can register the terminal device as needed without examining or judging whether the terminal device is registered.

Here, the present invention is the server wherein the storage unit may further store a contents list showing contents stored in the server, the server may further comprise a list transmitting unit operable to transmit the contents list to the terminal device, and the content to be transmitted on receipt of the request for the content may be selected from the contents list by the terminal device.

With this structure, the contents list is sent in accordance with the request by the terminal device. Therefore, the user can select the content from the contents list without performing complicated operations.

Here, the terminal device may further comprises a list obtaining unit operable to obtain, from each of a plurality of servers, a server contents list showing contents stored in the server, and a generating unit operable to generate the contents list by synthesizing the server contents lists.

With conventional techniques, in the case where a plurality of servers are connected, the user needs to judge which server stored a content to use, and perform a registration process against the server. However, the above structure enables the user to use the content just by selecting a content from contents list because terminal devices and servers perform a selection of servers and a judgment as to whether or not need to register.

The terminal device may further comprises a presenting unit operable to present the contents list to the user without partitioning the contents list according to transmission sources of the server contents lists, wherein the requesting unit may transmit the request for the content to a transmission source of the server contents list that contains the content selected by the user.

With this structure, the user can perform a registration process without specifying which server stores which contents.

### BRIEF DESCRIPTION OF THE DRAWING

FIG. 1 shows an overall structure of a device registration system 1;

FIG. 2 is a block diagram that shows an overall structure of a server A200;

FIGS. 3A-3D show an example of contents lists stored in a server and an example of contents select lists to be displayed on a monitor 106;

FIG. 4 is a block diagram that shows an overall structure of a terminal device 100;

FIG. 5 is a flowchart that shows how a server A200 and a server B300 operate;

FIG. 6 is a flowchart that shows how a terminal device 100 operates;

FIG. 7 shows how a device registration system 1 operates; and

FIG. 8 shows an example of contents select lists to be displayed on a monitor 106.

### EXPLANATION OF REFERENCES

1 device registration system
100 terminal device
101 input/output unit
102 contents obtaining unit
103 playback control unit
104 input unit
105 storage unit
106 monitor
107 speaker
200 server A
201 registration list storage unit
202 registration process unit
203 contents storage unit
204 contents list storage unit
205 ID storage unit
206 input/output unit
300 server B
400 TV
500 communication network

### BEST MODE FOR CARRYING OUT THE INVENTION

### First Embodiment

### 1. Overall Structure of a Device Registration System 1

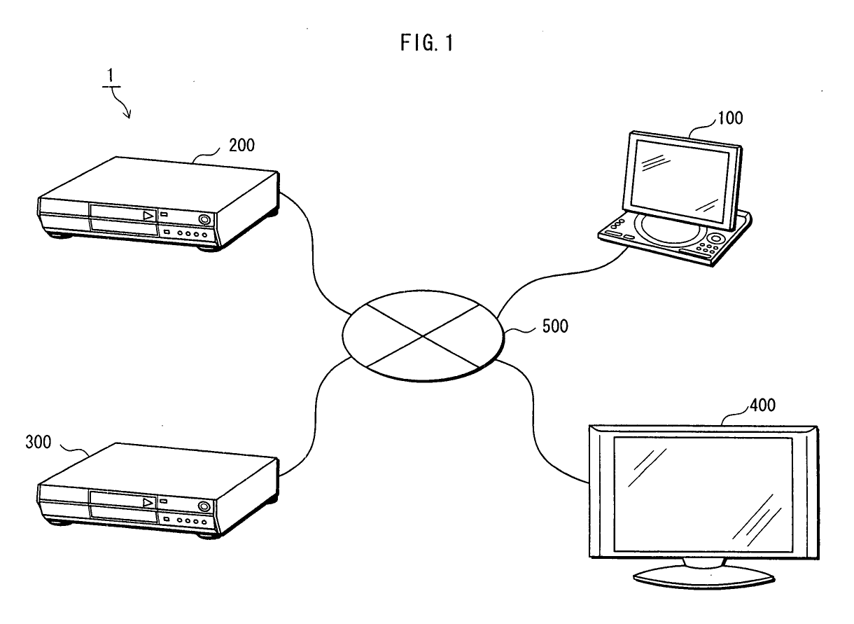

As shown in FIG. 1, a device registration system 1 includes a terminal device 100, a server A200, a server B300, a TV 400, and a communication network 500.

The server A200, the server B300, and the TV 400 are connected with each other via the communication network 500, and are set up in a house of a user. This forms a network. Here, the server A200, the server B300, and the TV 400 are connected with each other either directly or via an interchange device or the like.

Each of the server A200 and the server B300 stores a plurality of contents, and these contents are delivered to the TV 400 and viewed by the user.

Here, explanations of a structure of each device are provided based on the case where the terminal device is connected to the communication network 500 and a user use a content stored either in the server A200 or in the server B300.

It should be noted here that the structure of the server B300 is the same as the structure of the server A200, and an explanation is omitted.

### 1.1 Overall Structure of the Server A200

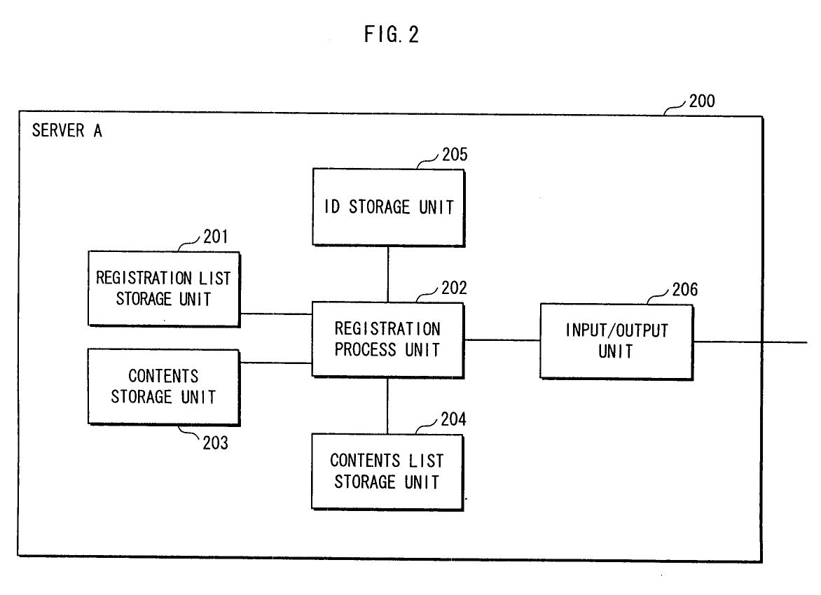

As shown in FIG. 2, the server A200 includes a registration list storage unit 201, a registration process unit 202, a contents storage unit 203, a contents list storage unit 204, an ID storage unit 205 and an input/output unit 206.

The server A200 is, more specifically, a computer system includes a micro processor, a ROM, a RAM, and a hard disk unit and the like. A computer program is stored in the RAM or the hard disk unit described above. When the micro processor operates in accordance with the computer program, the server A200 accomplishes its function.

The following explains each component of the server A200.

### (1) Contents Storage Unit 203, Contents List Storage Unit 204

A contents storage unit 203 stores a plurality of contents.

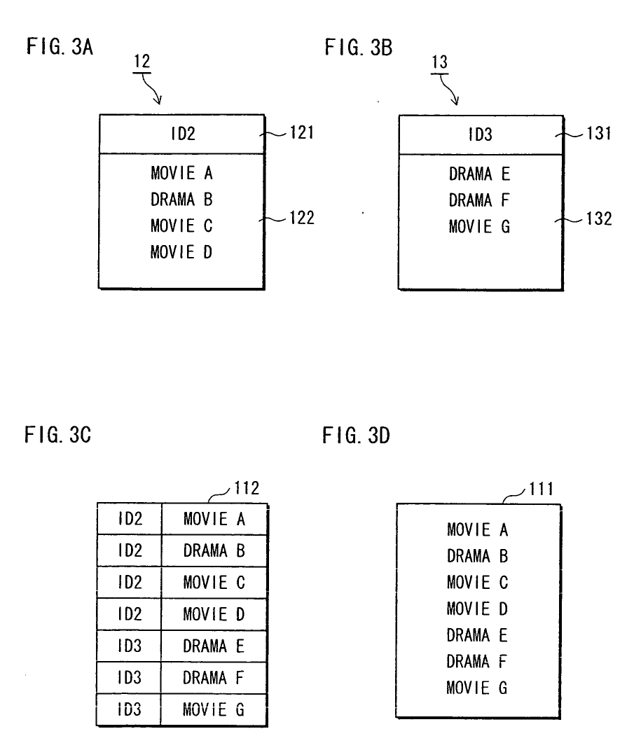

A contents list storage unit 204 stores a contents list 122 shown in FIG. 3A. The contents list 122 contains names of the contents stored in the contents storage unit 203. Any information may be registered as long as it can identify each content, ID of each content, and registering date and time. Also, when the contents are generated by the user, a date and time of creation should be registered.

The server B300 stores a contents list 132 shown in FIG. 3B. In the contents list 132, name of each content stored in the server B300 is registered.

### (2) ID Storage Unit 205

An ID storage unit 205 stores an identifier specific to the server A200. Here, the identifier specific to the server A200 is called an ID2.

### (3) Registration List Storage Unit 201

A registration list storage unit 201 stores a registration list.

In the registration list, an ID of a device that has been allowed to use the contents stored in the contents storage unit 203 and used the contents is registered.

In a case where the contents stored in the contents storage unit 203 is viewed on TV 400, and ID4 of the TV 400 is registered in the registration list.

(4) Registration process Unit 202, Input/Output Unit 206

An input/output unit 206 transfers data to and from other devices via the communication network 500.

Upon receiving a request to transmit IDs including ID1 of the terminal device 100 that uses the contents, the registration process unit 202 reads the ID2 from the ID storage unit 205 and transmits the read ID2 to the terminal device 100.

Also, upon receiving a request to transmit the contents list from the terminal device 100, the registration process unit 202 reads the contents list 122 from the contents list storage unit 204 and generates a contents list 12 by attaching the ID2 shown as an ID 121 in FIG. 3A, to the read contents list 122. Then, the registration process unit 202 transmits the contents list 12 to the terminal device 100 from which the request was transmitted to the registration process unit 202.

Further, when receiving a request to transmit a content selected from the contents list 12, the registration process unit 202 reads the registration list from the registration list storage unit 201 and judges whether the ID1 of the terminal device 100 from which the request is transmitted is registered. If the ID1 is registered, the registration process unit 202 permits a use of the content and reads the content selected from the contents storage unit 203, and transmits the selected content to the terminal device 100. On the other hand, if the ID1 is not registered, the registration process unit 202 transmits, to the terminal device 100, a register condition information indicating that the ID has not been registered and that it is not possible to use the content unless a registration process is performed, and whether to register. In consequence, if the terminal device 100 requests to register, the registration process unit 202 writes ID1 in the registration list, and reads the selected content and transmits it to the terminal device 100. If the terminal device 100 does not request to register, the registration process unit 202 does not register the ID1, and ends the process without transmitting the content to the terminal device 100.

It should be noted here that an aim of the present invention is to relieve users of bothers, and information registered in the registration process should at least identify a device to be registered. The information may be a serial number of a public key certification stored in the device to be registered, instead of the ID of the device.

Also, the registration process may be performed in combination with a device authentication that judges whether the device to be registered is authorized or other techniques that restrict a registration to the network. For example, when the number of devices that can be registered with the server A200 is limited and the number of the devices that has been registered with the server A200 does not reach the limit, a technique to register the ID1 of the terminal device 100 in the registration list of the server A200 is used. Also, there is a technique to transmit a packet for timing to measure time between a transmission of the packet and a reception of a response packet against the packet from the terminal device, and register the ID1 of the terminal device 100 if the time obtained by measurement is within a predetermined time.

### 1.2 Terminal Device 100

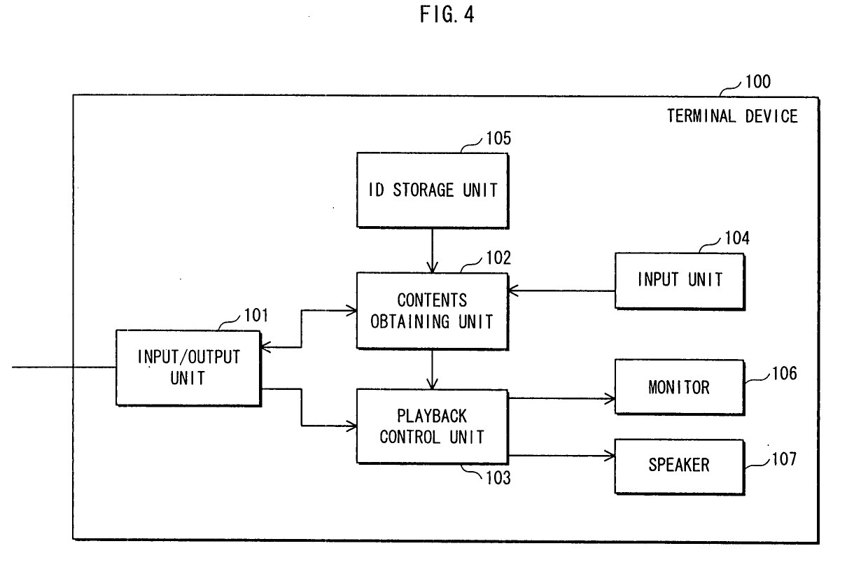

As shown in FIG. 4, a terminal device 100 includes an input/output unit 10, a contents obtaining unit 102, a playback control unit 103, an input unit 104, a ID storage unit 105, a monitor 106, and a speaker 107

As same as the server A200, the terminal device 100 is, more specifically, a computer system includes a micro processor, a ROM, a RAM, a hard disk unit, a display unit. When the micro processor operates in accordance with the computer program, the terminal device 100 accomplishes its function.

### (1) ID Storage Unit 105

The ID storage unit 105 stores an ID1 that is an identifier specific to the terminal device 100.

### (2) Monitor 106, Speaker 107, Input Unit 104

The monitor 106 shows a video signal received from the playback control unit 103. The speaker 107 inputs an audio signal received from the playback control unit 103.

The input unit 104 receives an input from the user and outputs it to the contents obtaining unit 102 as instruction information.

### (3) Input/Output Unit 101, Contents Obtaining Unit 102

The input/output unit 101 transmits data between other devices and the contents obtaining unit 102 or playback control unit 103 via the communication network 500.

The contents obtaining unit 102 performs a process concerning an obtainment of contents from the server A200 or the server B300.

First, the contents obtaining unit 102 receives an input of the instruction information that indicates the user views the contents. The contents obtaining unit 102 reads the ID1 from the ID storage unit 105, and transmits the read ID1 to devices in the whole network by broadcasting.

Also, the contents obtaining unit 102 receives an ID from each of devices connected to the network, and then, transmits, to the devices respectively corresponding the received IDs, a request to transmit a contents list stored in each of the devices. Here, for example, when receiving IDs from the server A200 and the server B300, the contents obtaining unit 102 sends a request to transmit the contents list to the server A200 and the server B300. If there is no response from the TV 400 that is in the same network via the communication network, and the contents obtaining unit 102 does not receive the ID of the TV 400, the contents obtaining unit 102 does not send the request.

After sending the request, the contents obtaining unit 102 receives the contents list from each device. The contents obtaining unit 102 receives the contents list 12 shown in FIG. 3A from the server A200 and the contents list 13 shown in FIG. 3B from the server B300. Then, the contents obtaining unit 102 extracts names of the contents from the contents list 12 and associates the ID2 of the server A200 with each name. Also, with respect to the contents list 13 received from the server B300, the contents obtaining unit 102 associates an ID3 of the server A300 with each name in a same manner. By putting these IDs and names as to the server A200 and IDs and names as to the server B300 together, a corresponding table 112 shown in FIG. 3D is generated. A contents select list 111 shown in FIG. 3C is generated by extracting only the names from the corresponding table 112. The contents obtaining unit 102 outputs, to the playback control unit 13, the contents list 111 and a message to have the user select the content in order to show the content on the monitor 106.

After the contents list is shown on the monitor 106, the input unit 104 receives a selection of the content from the users. When receiving an instruction information that specify the selected content from the input unit 104, the contents obtaining unit 102 checks the ID corresponding to the selected content on the corresponding table 112, and requests a server that is identified by the ID to transmit the selected content. Here, if the result of the check shows that the ID is the ID2, the contents obtaining unit 102 requests the server A200 to transmit the content.

When the contents obtaining unit 102 is permitted to use the content by the server A200, the contents obtaining unit 102 transfers a control to the playback control unit 103.

Also, when the contents obtaining unit 102 is not permitted to use the content and receives a registration condition information from the server A200, the contents obtaining unit 102 outputs, to the playback control unit 103, a message indicating that the terminal device 100 is not registered and that it is not possible to use the content unless a registration process is performed, and an option whether to register. When the input unit 104 receives an input from the users, the contents obtaining unit 102 receives an instruction information that shows an input from the users, and transmits, to the server A200, a response to request to perform a registration process or a response to show not registering depends on the instruction information.

When a registration process is not performed, the process ends without obtaining the content. When the contents obtaining unit 102 requests a registration process, the registration process is performed by the server A200. And, when a use of the content is permitted, the contents obtaining unit 102 transfers a function to control to the playback control unit 103.

### (4) Playback Control Unit 103

The playback control unit 103 receives the contents select list 111 and a message to promote a select of the content for users from the contents obtaining unit 102, generates an video signal and outputs it to the monitor 106. A message indicating that the terminal device 100 is not registered and it is not possible to use the content unless a registration process is performed, and whether to register are also output to the monitor 106.

Upon given control from the contents obtaining unit 102, and receiving a content from the server A200 or the server B300, the playback control unit 103 generates a video signal and an audio signal from the received content and outputs to the monitor 106 and to the speaker 107.

### 2. Operation of the Device Registration System 1

### 2.1 Operation of the Server A200

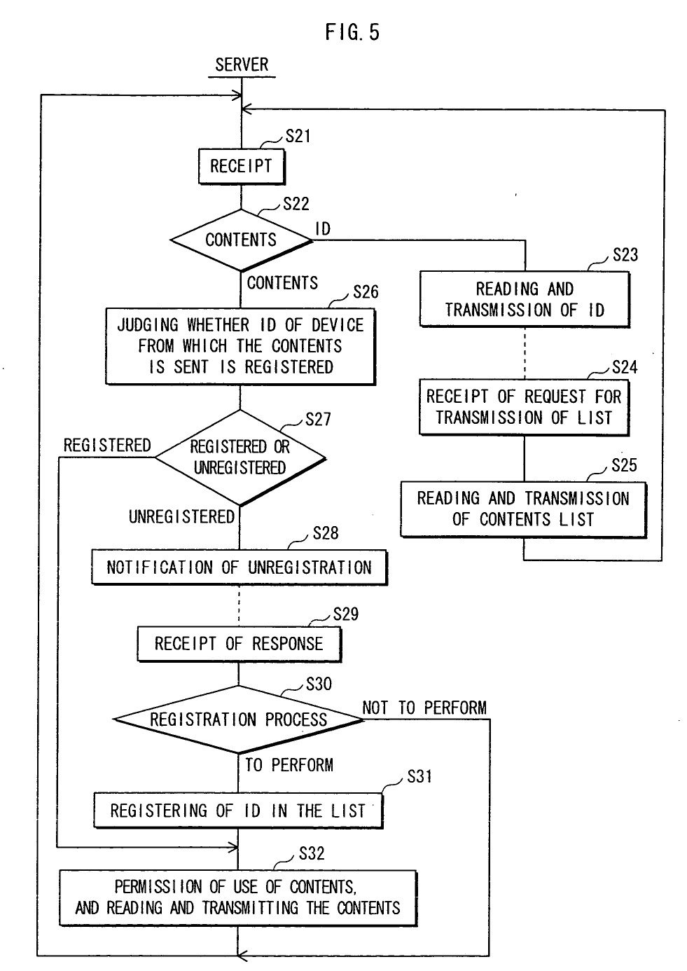

The following shows how the server A200 operates, with reference to FIG. 5. Here, an operation of the server B300 is the same as an operation of the server A200, therefore, an explanation is omitted.

A registration process unit 202 in the server A200 receives data from other devices via an input/output unit 206 (Step S21). If the contents received include IDs of other devices and request to transmit a server ID (ID in Step S22), the registration process unit 202 reads the ID2 of the server A200 and transmits the ID2 to a source host (Step S23).

Also, when receiving a request to transmit a contents list from the device (Step S24), the registration process unit 202 reads a contents list 122 from a contents list storage unit 204, generates a contents list 12 by attaching ID2, and transmits the contents list 12 to the device from which the request is transmitted.

Also, the registration process unit 202 receives data from other devices (Step S21), and when the data is to request to transmit the content (contents in Step S22), the registration process unit 202 reads a registration list from a registration list storage unit 201 and judges whether an ID of the device is registered in the registration list (Step S26). If the ID of the device is not registered (unregistered in Step S27), the registration process unit 202 transmits register condition information to the device (Step S28). Also, when receiving a response from the device (Step S29) and the response requests not to register (not to register in Step S30), the registration process unit 202 does not perform the rest of the process. If the response requests to register (to register in Step S30), the registration process unit 202 registers the ID of the device (Step S31), permits the device to use the content and reads the requested content from the contents storage unit 203 and transmits to the device (Step S32).

Also, when the ID of the device is registered in the Step S27, the registration process unit 202 permits the device to use the content without performing a registration process, and reads the content from the contents storage unit 203 (Step S32).

### 2.2 Operation of the Terminal Device 100

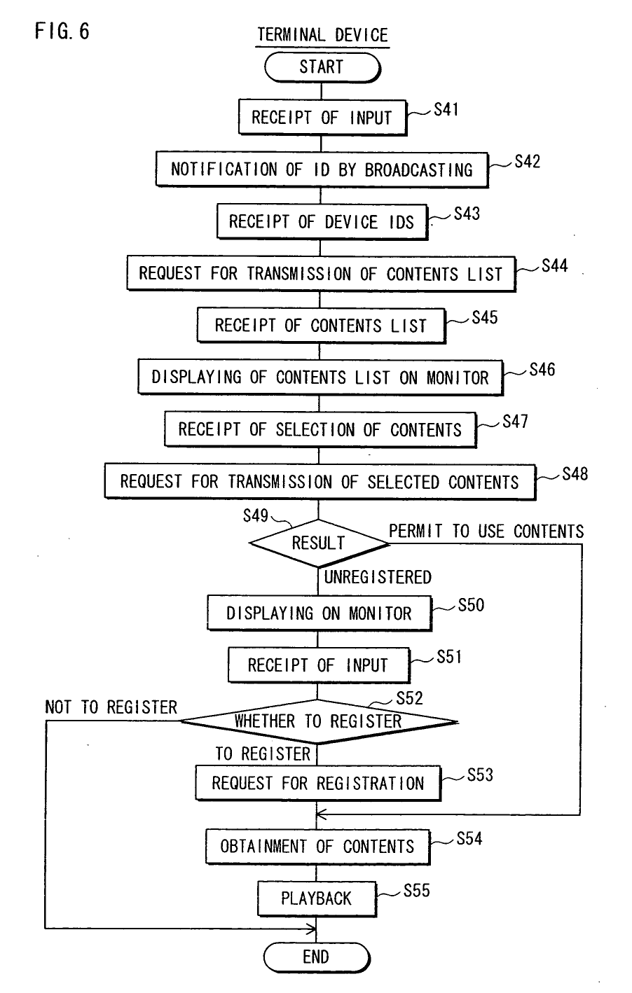

The following explains how the terminal device 100 operates, with reference to FIG. 6.

The terminal device 100 is connected to the network via the communication network 500. The contents obtaining unit 102 reads, when receiving an instruction information that instructs to obtain the content from the input unit 104 (Step S41), an ID1 from the ID storage unit 105 and transmits the read ID1 to the devices in the whole network by broadcasting (Step S42).

Also, when receiving an ID of another device after the ID1 is sent to the devices in the whole network (Step S43), the contents obtaining unit 102 requests to transmit the contents list to a device that is specified by the received ID (Step S44).

When receiving a contents list from other devices (Step S45), the registration process unit 202 generates a corresponding table from the list. Further, the contents obtaining unit 102 extracts the names of the contents from the corresponding table to generate contents select list, and outputs to the playback control unit 103. The playback control unit 103 displays the contents select list on the monitor 106 (Step S46).

When receiving a selection of the content from the input unit 104 according to an operation by a user (Step S47), the contents obtaining unit 102 searches for IDs corresponding to the contents selected from the corresponding table 112 and requests the device that has the IDs to transmit the contents (Step S48).

The contents obtaining unit 102 receives, from the device to which the contents obtaining unit requests to transmit the content, result of a judgment as to whether the terminal device 100 is registered or not. If the result is a register condition information (unregistered in Step S49), the playback control unit 103 displays, on the monitor 106, a register condition information indicating that the terminal device 100 is not registered and it is not possible to use the content unless a registration process is performed, and an option as to whether to register (Step S50). The contents obtaining unit 102 receives instruction information that shows whether or not to register from the input unit 104 (Step S51). If the instruction information requests not to register (not to register in Step S52), the contents obtaining unit 102 ends the rest of the process without obtaining the content. If the instruction information requests to register (to register in Step S52), the contents obtaining unit 102 requests the device to register (Step S53). When the terminal device 100 is registered in the device and is permitted to use the content, the contents obtaining unit 102 transfers a control to the playback control unit 103. Upon receiving the requested content via the input/output unit 101 (Step S54), the playback control unit 103 generates a video signal and an audio signal from the data of the content and plays back the content by outputting these signals to the monitor 106 and the speaker 107 (Step S55). On the other hand, if the terminal device 100 is registered with the requesting source device and is permitted to use the content, the contents obtaining unit 102 transfers a control to the playback control unit 103, and the playback control unit 103 plays back the content received via the input/output unit 101 (Step S55).

### 2.3 Operation of the Whole Device Registration System 1

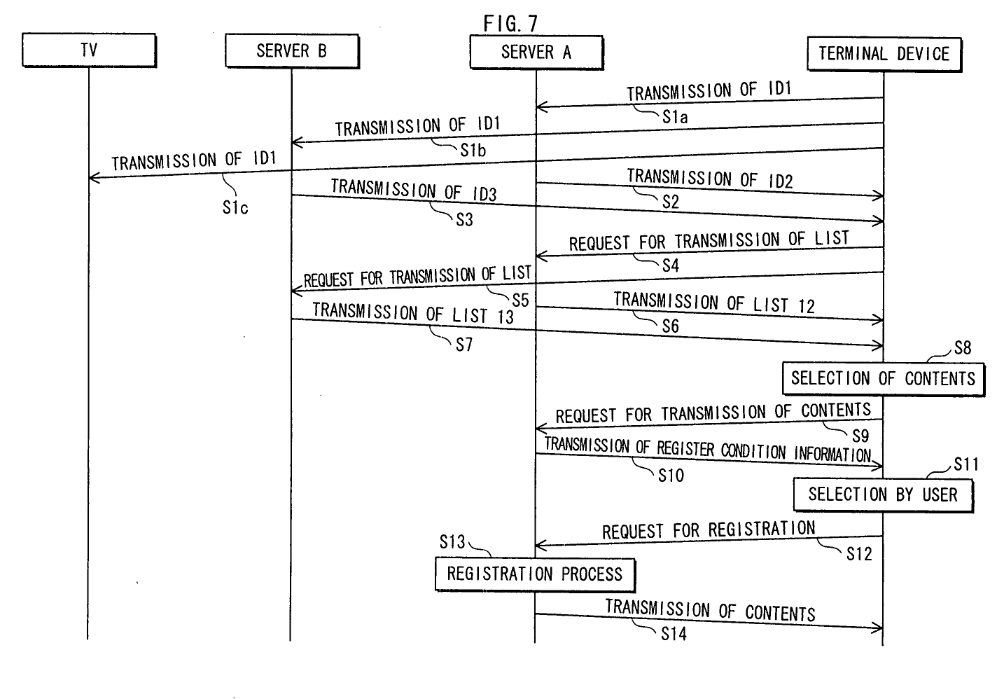

The following explains, with reference to FIG. 7, how each of the devices connected to the network of the device registration system operates, focusing on transmitting and receiving of data.

Here, the explanation is provided based on a case where a content stored in the server A200 is selected from a terminal device 100 that is newly connected to the network.

The terminal device 100 transmits the ID1 to other devices in the whole network by broadcasting and requests IDs of other devices (Step S1a to Step S1c). The server A200 and the server B300 respectively transmit their respective IDs to the terminal device 100 (Step S2, S3).

Here, the explanation is provided based on a case where the terminal device 100 receives the IDs of the server A200 and the server B300 and has failed to receive the ID of the TV 400.

The terminal device 100 requests the server A200 and the server B300 to transmit the contents list (Step S4, S5). The terminal device 100 does not request anything to the TV 400 from which the ID has not been transmitted.

The server A200 and the server B300 respectively read the contents lists and attach IDs to the contents lists, and then transmit to the terminal device 100 (Step S6, S7).

The terminal device 100 receives the contents list 12 and the contents list 13 from the server A200 and the server A300 respectively and generates a corresponding table. Then the terminal device 100 extracts the names of the contents from the corresponding table and displays a contents select list 111 on the monitor 106, and receives a selection from a user (Step S8). The terminal device 100 refers to the corresponding table and requests the server A200 that stores the selected content to transmit the content (Step S9). The terminal device 100 does not request anything to the server B300 that does not have the selected content.

The server A200 judges whether the ID of the terminal device 100 is registered in the registration list. Since the terminal device 100 is not registered, the server A200 transmits register condition information (Step S10).

Upon receiving an input to register from the user (step S11), the terminal device 100 requests the server A200 for a registration (Step S12).

The server A200 performs a registration process by registering the ID1 in the registration list (Step S13). Also, the server A200 permits the terminal device 100 to use the content, and transmits the requested content to the terminal device 100 (Step S14).

### 3. Other Issues

Here, the explanation of the device registration system of the present invention is provided based on the embodiment above. However, the present invention should not be limited to this. For example, the following can be applied to the device registration system.

(1) In the embodiment above, the server A200 registers the terminal device 100 by registering an ID of the terminal device 100. However, the server A200 may transmit a certification of a registration to the terminal device 100. In this case, when the terminal device 100 that has been registered requests to transmit the contents, the terminal device 100 transmits the certification to the server A200. The server A200 examines the certification to check if the certification is valid and whether the terminal device 100 has been surely registered, and then permits the terminal device 100 to use the requested content.
(2) In the embodiment above, a judgment as to whether the terminal device 100 is registered in a registration list is performed after the content are selected from a contents list. However, the registration list may be checked when the terminal device is notified of the ID2, and a result of the judgment is transmitted to the terminal device 100.

Also, the registration list may be checked when a server requests to transmit the contents. In this case, when the server displays the contents select list, whether or not the terminal device 100 is registered in the server that stores each content may be displayed on the monitor 106.

Here, an explanation is provided based on a case where the terminal device 100 is registered in the server B300 and is not registered in the server A200.

Upon receiving a request to transmit the contents from the terminal device 100, each of the server A200 and the server B300 judges whether the terminal device 100 is registered in a registration list and transmits a result of the judgment together with the contents list.

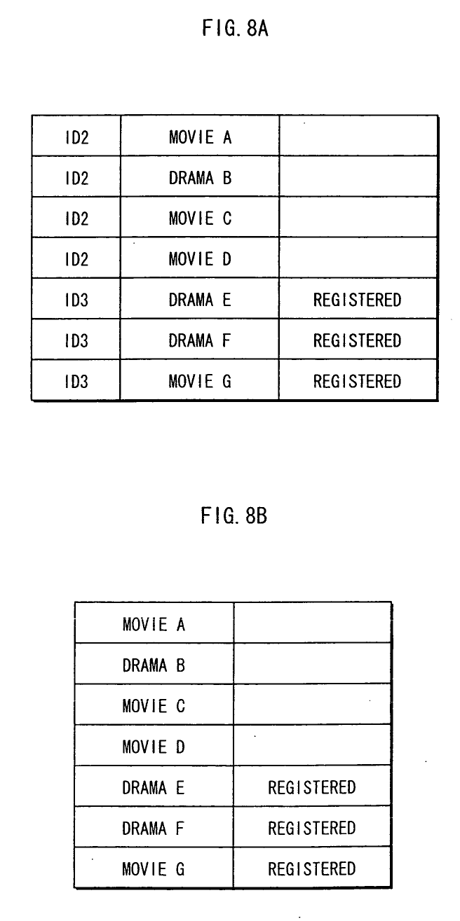

The terminal device 100 receives a contents list 12 and a result showing that the terminal device is unregistered from the server A200, and also receives a contents list 13 and a result showing that the terminal device 100 has been registered from the server B300. When generating a corresponding table, the contents obtaining unit 102 associates names of the contents extracted from the contents list 13 with register information indicating that the terminal device 100 is registered, as shown in FIG. 8A. Any register information is not associated with names of contents extracted from the contents list 12. A massage indicating that the terminal device 100 is not registered may be attached.

As shown in FIG. 8B, the terminal device 100 extracts names of the contents and the register information and shows on the monitor 106 as a contents select list.

(3) In the embodiment above, the server A200 and the server B300 is requested to transmit the contents list and transmit the contents list to the terminal device 100 after transmitting an ID to the terminal device 100. However, the contents list may be sent together with the ID. The order as to which is sent first, the contents list or the ID, does not matter.
(4) The embodiment of the present invention can be performed under a protocol of UPnP (Universal Plug and Play). A notification of the ID by a control point or by broadcasting of the UpnP corresponds to SSDP (Simple Service Discover Protocol) of the UpnP. The terminal device 100 may transmit its ID to a sub-network by the SSDP, and may receive a response from a device that is connected to the sub-network. The UPnP is also used for requesting a contents list. Here, the UPnP is a technical convention that allows devices connected to a network such as PCs or peripherals to recognize each other and to function, as explained in Non-patent Document 1.

The UPnP is a collection of techniques that are internet-based communication standards, such as XML (eXtensible Markup Language), DHCP (Dynamic Host Configuration Protocol), SOAP (Simple Object Access Protocol, GENA (General Event Notification Architecture), and automatically recognizes the devices that are connected to the network, and performs a control by exchanging information among the devices.

(5) In the embodiment, the server A200 and the server B300 are connected to the network, however, the present invention is not limited to this. For example, only the server A200 may be connected to the network. Also, a plurality of servers and terminal devices may be connected to the network.
(6) In the embodiment, the terminal device 100 does not store contents. However, the present invention is not limited to this. The terminal device 100 may store contents. Also, the terminal device 100 may temporality store contents obtained from other devices, and then play back according to an input from the user.
(7) In the embodiment, when a terminal device is not registered, a registration process is performed according to an input from the user. However, the present invention is not limited to this. If a terminal device is not registered, the server may perform a registration process by a default.
(8) The present invention may be the above-described method. The present invention may be a computer program which realizes the method. The present invention may also be a digital signal represented by the computer program.

Further, the present invention may be the computer program or the digital signal recorded on a computer-readable recording medium, such as a flexible disk, a hard disk, a CD-ROM, an MO, a DVD, a DVD-ROM, a BD (Blu-ray Disc), and a semiconductor memory. Also, the present invention can be the computer program recorded in these recording media or the digital signal.

The present invention may be realized by transmission of the computer program, the digital signal via a telecommunication circuit, a wireless or wired communication line, or a network such as the Internet.

Also, the present invention may be a computer system including a microprocessor and a memory in which the memory stores the computer program, and the microprocessor operates according to the computer program.

The present invention may be carried out by another independent computer to which the program or the digital signal recorded on the recorded medium is transmitted, or the program or the digital signal is transmitted via a network.

(9) The embodiment and the modifications described above may be combined together.

### INDUSTRIAL APPLICABILITY

In a software industry that supplies software such as computer programs or contents in which copyrighted works such as movies and music are digitized, the present invention can be used economically, repeatedly, and continuously. Also, the device registration system, the server, and the terminal device of the present invention can be manufactured and sold in a manufacturing industry of electrical products.

1. A device registration system including a server and a terminal device obtaining and using the contents from the server,
the terminal device comprising:
a selection receiving unit operable to receive, according to input by a user, a selection of a content from a contents list showing the contents stored in the server; and
a requesting unit operable to transmit, to the server, a request for the selected content, and
the server comprising:
a receiving unit operable to receive the request for the selected content from the terminal device; and
a registration unit operable to register the terminal device on receipt of the request for the selected content.

2. A server that stores contents to be used by a terminal device, the server comprising:
a receiving unit operable to receive, from the terminal device, a request for a content among the contents; and
a registration unit operable to register the terminal device on receipt of the request for the content.

3. The server of claim 2 further comprising:
a storage unit operable to store a registration list;
a specific information receiving unit operable to receive information specific to the terminal device which is a source of the request; and
a judging unit operable to judge whether the received information is registered in the registration list, wherein
if the judging unit judges negatively, the registration unit registers the terminal device by writing the received information in the registration list.

4. The server of claim 3, wherein
the registration unit includes:
a notifying subunit operable, if the judging unit judges negatively, to notify the terminal device that the received information is not registered in the registration list;
a request receiving subunit operable to receive a request for registration from the terminal device; and
a writing subunit operable to write the received information in the registration list on receipt of the request for registration from the terminal device.

5. The server of claim 3, wherein
the judging unit judges after the receiving unit receives the request for the content.

6. The server of claim 3, wherein
the storage unit further stores a contents list showing contents stored in the server,
the server further comprises a list transmitting unit operable to transmit the contents list to the terminal device, and
the content to be transmitted on receipt of the request for the content is selected from the contents list by the terminal device.

7. The server of claim 6, wherein
the list transmitting unit receives a request for the contents list from the terminal device and transmits the contents list on receipt of the request for the contents list, and
the judging unit judges after the list transmitting unit receives the request for the contents list.

8. The server of claim 3, wherein
the judging unit judges after the specific information receiving unit receives the information.

9. A terminal device that obtains and uses contents stored in a server, the terminal device comprising:
a selection receiving unit operable to receive, according to input by a user, a selection of a content from a contents list showing the contents stored in the server; and
a requesting unit operable to transmit, to the server,
a request for the selected content, wherein the server registers the terminal device on receipt of the request for the content.

10. The terminal device of claim 9, further comprising:
a list obtaining unit operable to obtain, from each of a plurality of servers, a server contents list showing contents stored in the server, and
a generating unit operable to generate the contents list by synthesizing the server contents lists.

11. The terminal device of claim 10, further comprising:
a presenting unit operable to present the contents list to the user without partitioning the contents list according to transmission sources of the server contents lists, wherein
the requesting unit transmits the request for the content to a transmission source of the server contents list that contains the content selected by the user.

12. The terminal device of claim 10, further comprising:
a storage unit operable to store an identifier identifying the terminal device; and
a transmitting unit operable to transmit the identifier to the servers by broadcasting, wherein
the list obtaining unit receives an identifier identifying a server, and transmits a request for the server contents list to a transmission source of the server identifier, and obtains the server contents list.

13. The terminal device of claim 12, wherein
the requesting unit, the contents list obtaining unit, and the transmitting unit are control points of a universal plug and play.

14. A device registration method used in a server that stores contents used by a terminal device, the device registration method comprising:
a receiving step of receiving, by a receiving unit, a request for a content among the contents from the terminal device; and
a registration step of registering, by a registration unit, the terminal device on receipt of the request for the content.

15. A device registration program used in a server that stores contents used by a terminal device, the device registration program comprising:
a receiving step of receiving, by a receiving unit, a request for a content among the contents from the terminal device; and
a registration step of registering, by a registration unit, the terminal device on receipt of the request for the content.

16. A computer-readable recording medium in which a device registration program used by a server that stores contents used by a terminal device is recorded, the device registration program comprising:
a receiving step of receiving, by a receiving unit, a request for a content among the contents from the terminal device; and
a registration step of registering, by a registration unit, the terminal device on receipt of the request for the content.
